(19) United States
(12) Patent Application Publication
(10) Pub. No.: US 2015/0061340 A1
(43) Pub. Date: Mar. 5, 2015

(54) Head Hammock

(71) Applicant: Barbara J. Fleming, Colorado Springs, CO (US)

(72) Inventor: Barbara J. Fleming, Colorado Springs, CO (US)

(21) Appl. No.: 14/013,908

(22) Filed: Aug. 29, 2013

(51) Int. Cl. B60N 2/48

(52) U.S. Cl. CPC B60N 2/4805
USPC 297/391

(57) ABSTRACT

A head hammock for supporting the head of a sitting sleeper, comprising a flexible fabric oblong shaped sling having opposed elongated end portions each of which forms a web and each of which includes a distal end, a buckle for interconnecting the distal ends of the elongated webs to form an endless loop, and a fastener disposed on each of the webs for selectively adjusting the size of the endless loop.

### BACKGROUND

Passenger travelers in airplanes, buses and cars often tend to fall asleep; however such total relaxation allows the head of the sitting passenger to fall to the side or onto the chest. Such movement either awakens the sleeper or if not presents the sleeper with a sore neck upon wakening. The object of the present invention is to provide a compact device that can be attached to the vehicle's passenger seat and which will softly cradle the head of the sleeper to maintain the head in an upright position during sleep.

### SUMMARY OF THE INVENTION

The head hammock of the present invention includes an oblong shaped flexible fabric sling for holding a sitting passenger's head in an upright position while sleeping. The sling is supported by its opposed elongated end portions that are interconnected to form an endless loop that encircles the upper portion of the passenger seat.

### DESCRIPTION OF THE DRAWINGS

FIG. 1 is a perspective view of a typical airline passenger using the head hammock of the present invention.

FIG. 2 is an upper perspective view of the head hammock with its elongated end portions interconnected by a triglides type of buckle.

FIG. 3 is a fragmental frontal view of the head hammock.

FIG. 4 is a fragmental side view of the head hammock.

FIG. 5 is a cross sectional view of the head hammock taken along lines 5-5 of FIG. 3.

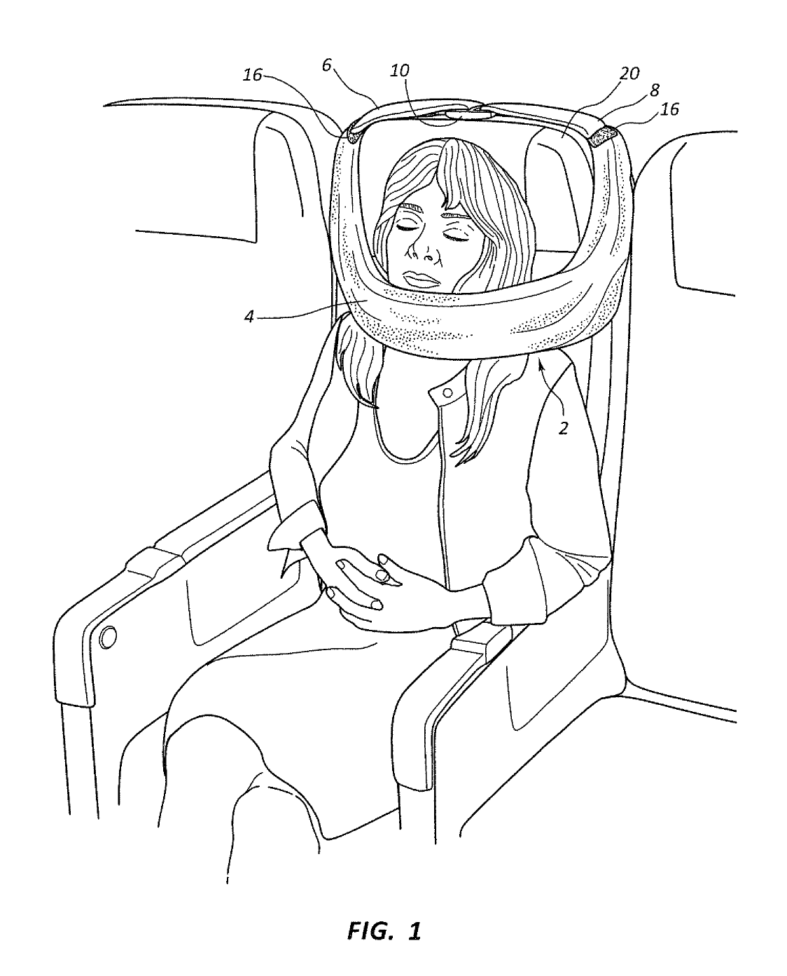

### DETAILED DESCRIPTION

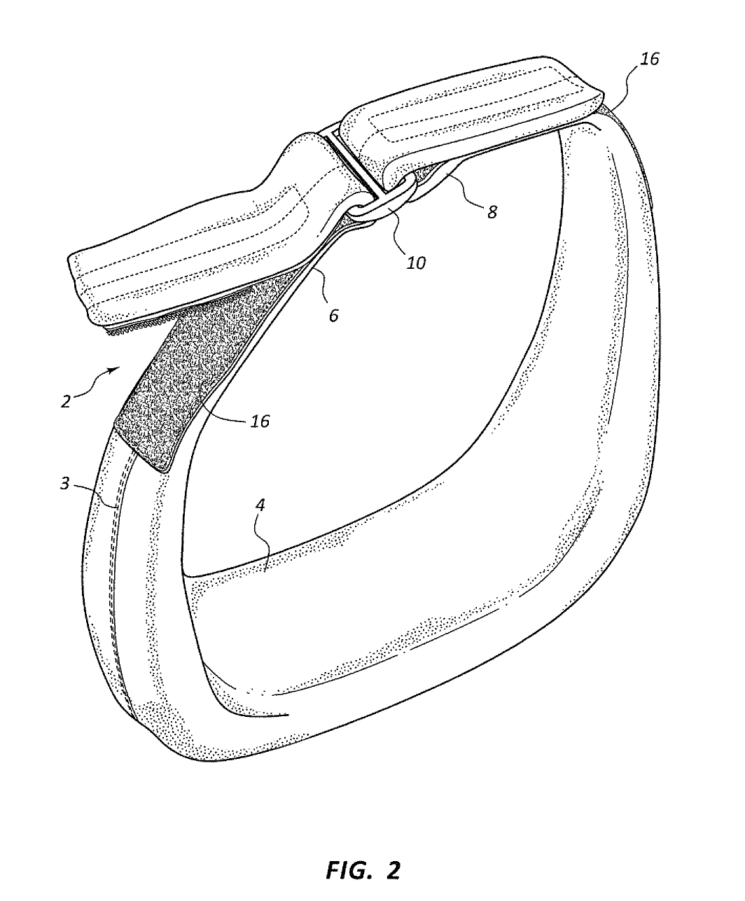

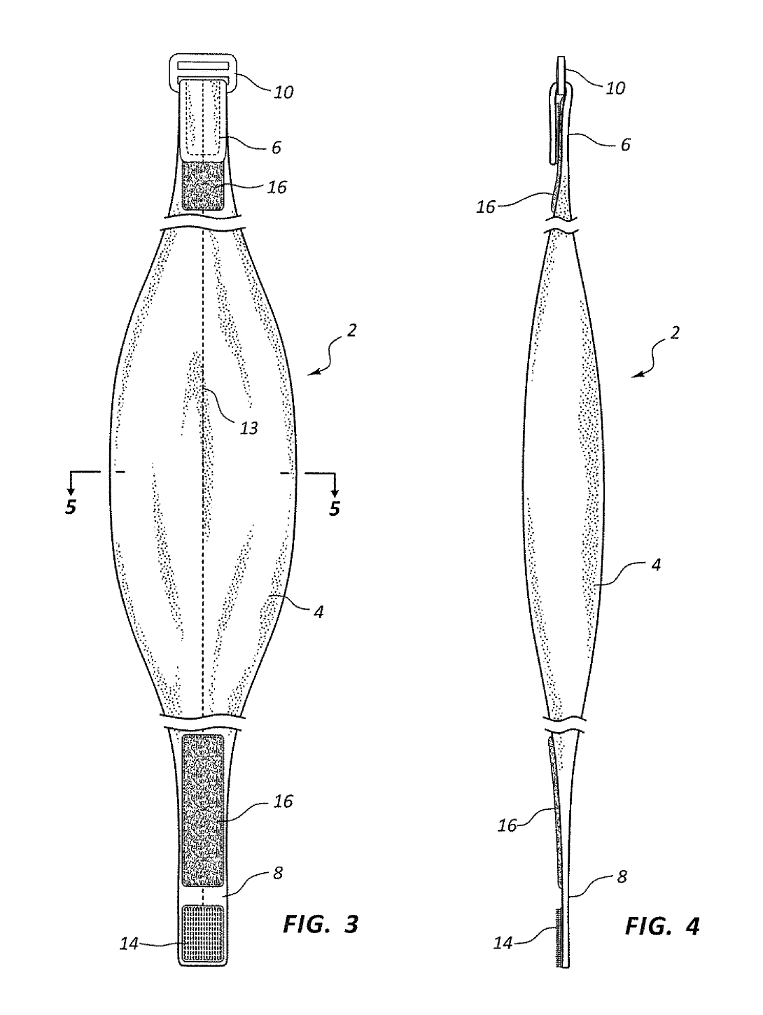

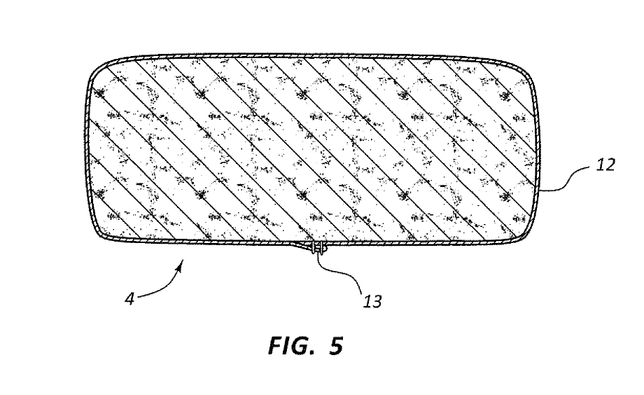

The details of the construction of the head hammock 2 are best illustrated in FIGS. 2 and 3 where the hammock is seen to include an oblong shaped body 4 constructed of soft flexible fabric, for example, chenille or terry cloth. The body includes integral elongated end portions 6 and 8 which form respective webs that are intended to be interconnected by a buckle 10 to form an endless loop, as shown in FIG. 2, Preferably, the body and the web forming end portions are constructed in the form of an enclosed envelope 12 to provide the body with more substance than would be provided by a single thickness of material. The seam 13 where the edges of the material are joined is on the outer side of the envelope in order to provide maximum comfort to the user. The end portions 6 and 8 are provided with strips of hook and loop fastening material 14 and 16 to accommodate adjustable closure of the endless loop.

In use, the ends 6 and 8 of the head hammock are wrapped around the upper portion 20 of the passenger seat and are secured in position with the hook and loop fasteners so as to support the passenger's head during sleep.

I claim:

1. A head hammock for supporting the head of a sitting sleeper, comprising
a flexible fabric oblong shaped sling having opposed elongated end portions each forming a web and each of which includes a distal end,
buckle means for interconnecting the distal ends of the elongated webs to form an endless loop, and
fastening means disposed on each of the webs for selectively adjusting the size of the endless loop.

2. The head hammock of claim 1 where the fastening means includes hook and loop fasteners.

3. The head hammock of claim 2 where the sling comprises an envelope of the flexible fabric and having a closing seam aligned with the long dimension of the sling.

4. The head hammock of claim 3 where the flexible fabric is chenille.

5. The head hammock of claim 1 where the buckle means is a triglides slide.
